(19) United States
(12) Patent Application Publication
(10) Pub. No.: US 2026/0339100 A1
(43) Pub. Date: Oct. 29, 2026

(54) BRIGHTNESS-BASED EXTENDED REALITY (XR) LENS TRANSPARENCY ADJUSTMENTS

(71) Applicant: Hewlett-Packard Development Company, L.P., Spring, TX (US)

(72) Inventors: Ling-I Hung, Taipei City (TW); Yow-Wei Cheng, Taipei City (TW); Yew-Chung Hung, Taipei City (TW)

(73) Assignee: Hewlett-Packard Development Company, L.P., Spring, TX (US)

(21) Appl. No.: 19/120,195

(22) PCT Filed: Oct. 20, 2022
(86) PCT No.: PCT/US2022/047336

§ 371 Date: Apr. 10, 2025

(51) Int. Cl. G02B 27/01; G06T 7/73; G06T 11/10

(52) U.S. Cl. CPC G02B 27/0172; G06T 7/73; G06T 11/10; G02B 2027/0118; G06T 2207/10016; G06T 2210/12

(57) ABSTRACT

In an example in accordance with the present disclosure, an extended reality system (XR) is described. The XR system includes a lens through which a user is to view a physical scene and onto which virtual content is displayed and a frame to retain the lens in front of the user. The XR system includes an imaging system to present the virtual content on the lens and a switch layer disposed over the lens. The switch layer has a selectively alterable transparency. A front-facing sensor measures an ambient brightness of the physical scene. A tracking system of the XR system records a position and orientation of objects in the physical scene and a controller applies an electrical voltage to the switch layer to adjust a strength of light passing through the lens. The applied voltage is based on a measured brightness of the physical scene.

### BACKGROUND

Extended reality (XR) environments present a visual display of digital content with which a user can interact. Virtual reality (VR) systems generate a computer-generated depiction of a real or artificial world. A mixed reality (MR) system is an interactive depiction of a combined real-world and computer-generated environment. Augmented reality (AR) depicts the real-world environment with computer-generated enhancements. In each of these environments, a user may interact with the computer-generated objects within the environment.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an extended reality (XR) system with adjustable lens transparency, according to an example of the principles described herein.

FIGS. 2A-2C are diagrams of the XR system with adjustable lens transparency, according to an example of the principles described herein.

FIG. 3 is a flow chart of a method for selectively adjusting lens transparency, according to an example of the principles described herein.

FIG. 4 depicts an augmented reality (AR) scene presented on the XR system, according to an example of the principles described herein.

FIG. 5 is a flow chart of a method for selectively adjusting lens transparency, according to an example of the principles described herein.

FIG. 6 depicts a non-transitory machine-readable storage medium for selectively adjusting lens transparency, according to an example of the principles described herein.

Throughout the drawings, identical reference numbers designate similar, but not necessarily identical, objects. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Extended reality (XR) systems present an environment wherein a user can interact with digital objects within an XR environment. XR systems include virtual reality (VR) systems, augmented reality (AR) systems, and mixed reality (MR) systems. A VR system presents virtual imagery representative of physical spaces and/or objects. AR systems provide a real-world view of a physical environment with virtual imagery/objects overlaid thereon. MR systems re-create a real world to a user with virtual imagery/objects overlaid thereon when the user does not have a direct view of the real world.

XR systems may include head-mounted displays (HMDs) or AR glasses to present the computer-generated objects to the user. As a specific example, AR glasses include a transparent lens through which a user views the physical world. In this example, the XR system projects virtual content onto the transparent lens. This virtual content may be projected at locations on the lens to have a particular relative position to the real-world physical objects viewable through the transparent lens. For example, a user may be looking through AR glasses at a physical scene with a tree in a background and grass in the foreground. In this example, a virtual avatar of a user or animal may be projected on the transparent lens to be between the tree and the grass. As such, the AR glasses present a scene with virtual objects superimposed over a real-world scene visible through the transparent lens.

Extended reality (XR), of which AR is a sub-class, is emerging as a desirable computing platform for facilitating communication as XR may enhance collaboration; present information in a palatable, enjoyable, and effective manner; and introduce new immersive environments for entertainment, productivity, or other purposes. XR systems are found in many industries including healthcare, telecommunication, education, and training, among others. While XR systems undoubtedly have changed, and will continue to change, the way individuals communicate, some technological advancements may further increase their impact on society.

For example, presenting virtual content on a transparent substrate in a well-lit environment may reduce the overall visibility of the virtual content due to a lack of contrast. As a specific example, when worn in an outdoor environment with plenty of sunlight, virtual content projected onto a transparent lens of the AR glasses may be difficult to discern. In other words, the amount of available ambient light affects, either positively or negatively, a viewability of the virtual content superimposed over a physical environment.

Accordingly, the present specification describes systems, methods, and machine-readable program code that detects the ambient light in an environment and automatically alters operation of the XR system to enhance contrast and virtual content viewability. Specifically, the present specification provides a switch layer formed over the lens where the virtual content is to be displayed. The switch layer is a membrane or film whose transparency may be adjusted based on an applied voltage. Accordingly, based on a detected ambient light, a voltage may be applied to the switch layer to change the transparency of the lens to achieve a target contrast ratio between the light passing through the lens and the virtual content. As such, virtual content is presented with sufficient contrast to the background physical environment, regardless of the lighting conditions of the physical environment.

Specifically, the XR system includes 1) a lens through which the user is to view a physical scene and onto which virtual content is to be displayed and 2) a frame to retain the lens in front of the user. An imaging system of the XR system presents the virtual content on the lens. A switch layer is disposed over the lens, which switch layer has a selectively alterable transparency. A front-facing sensor measures an ambient brightness of the physical scene and a tracking system records a position and orientation of objects in the physical scene. A controller of the XR system applies an electrical voltage to the switch layer to adjust a strength of light passing through the lens, which electrical voltage value is based on a measured brightness of the physical scene.

The present specification also describes a method. According to the method, an XR system obtains pixel coordinates of virtual content from a perspective of a front-facing sensor of the XR system. A controller determines a boundary region of the virtual content based on the pixel coordinates of the virtual content from the perspective of the front-facing sensor. The front-facing sensor determines an ambient brightness of a portion of the physical scene visible through the lens and within the boundary region. The controller applies an electrical voltage to a switch layer overlying the lens to adjust a transparency of light passing through the lens. As described above, a value of the electrical voltage is based on a measured brightness of the physical scene within the boundary region.

The present specification also describes a non-transitory machine-readable storage medium encoded with instructions executable by a processor. The machine-readable storage medium includes instructions to, when executed by the processor, present virtual content on a lens of an XR system, wherein a user views a physical scene through the lens. The instructions are also executable by the processor to 1) obtain pixel coordinates of the virtual content and 2) determine, based on the pixel coordinates, a boundary region of the virtual content. The instructions are also executable to 1) measure, with a front-facing sensor, an ambient brightness of the physical scene within the boundary region and 2) based on the measured brightness, adjust a contrast between the physical scene visible through the lens and the virtual content by selectively altering a transparency of a switch layer overlying the lens.

In summary, such a system, method, and machine-readable storage medium may, for example, 1) provide a target contrast ratio between virtual content displayed on a transparent lens and real-world physical objects viewable through the transparent lens; 2) are lightweight without an accessory component for the XR system; 3) automatically adjust the contrast; 4) determine transparency based on ambient light specifically around the virtual content; and 5) are power efficient. However, it is contemplated that the devices disclosed herein may address other matters and deficiencies in a number of technical areas, for example.

As used in the present specification and in the appended claims, the term “controller” refers to a component that includes a processor and a memory device. The processor includes the circuitry to retrieve executable code from the memory and execute the executable code. As specific examples, the controller as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification and in the appended claims, the term “memory” or “memory device” includes a non-transitory storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement the functionality described herein. The memory may include a single memory object or multiple memory objects.

Further, as used in the present specification and in the appended claims, the term XR environment refers to that environment presented by the XR system and may include an entirely digital environment, or an overlay of a digital environment on a physical scene viewed by the user. For example, the XR environment may be a VR environment which virtual imagery representative of physical spaces and/or objects. AR environments provide a real-world view of a physical environment with virtual imagery/objects overlaid thereon. MR environments re-create a real world to a use with virtual imagery/objects overlaid thereon when the user does not have a direct view of the real world.

As used in the present specification and in the appended claims, the term “a number of” or similar language is meant to be understood broadly as any positive number including 1 to infinity.

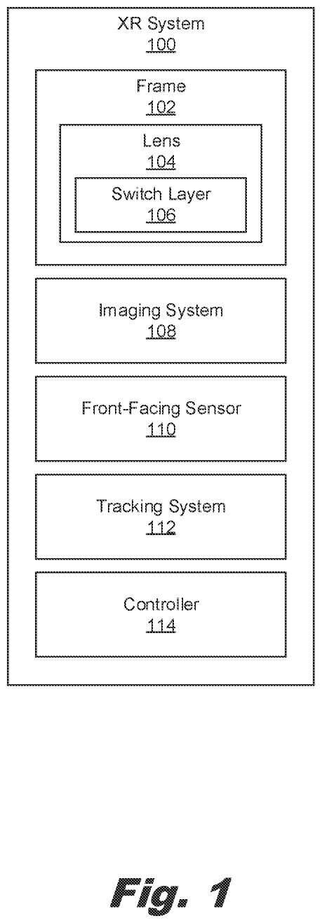

Turning now to the figures, FIG. 1 is a block diagram of an extended reality (XR) system (100) with adjustable lens transparency, according to an example of the principles described herein.

As described above, the term XR encompasses, VR, MR, and AR such that an XR system (100) encompasses VR systems, MR systems, and AR systems. The content that is displayed on the XR system (100) may be provided by the XR system (100) itself or a host computing device such as a personal computer (PC), all-in-one device, gaming console, or the like. Accordingly, the XR system (100) may include an input port or transceiver to receive the virtual content from a connected host computing device, which virtual content is to be displayed on the lens of the XR system. Note that while the present application relates to XR systems, the term virtual content is used to refer to the digital content in each of the VR, MR, and AR environments, as opposed to the physical-world objects, that may be present in these environments.

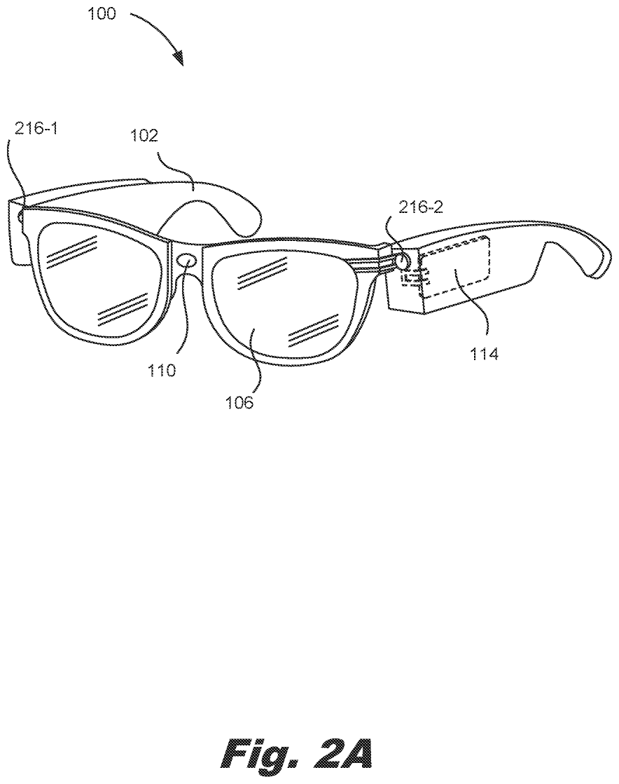

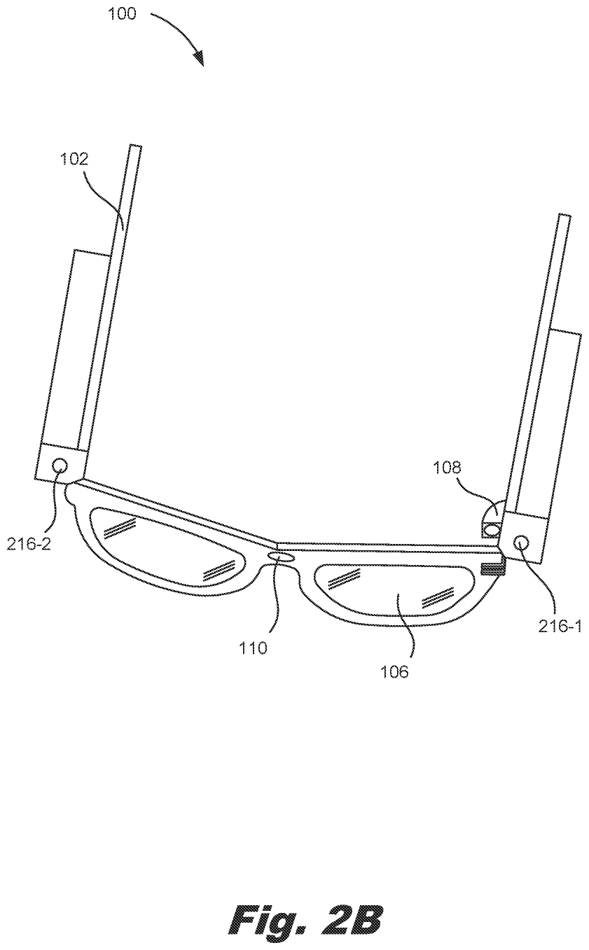

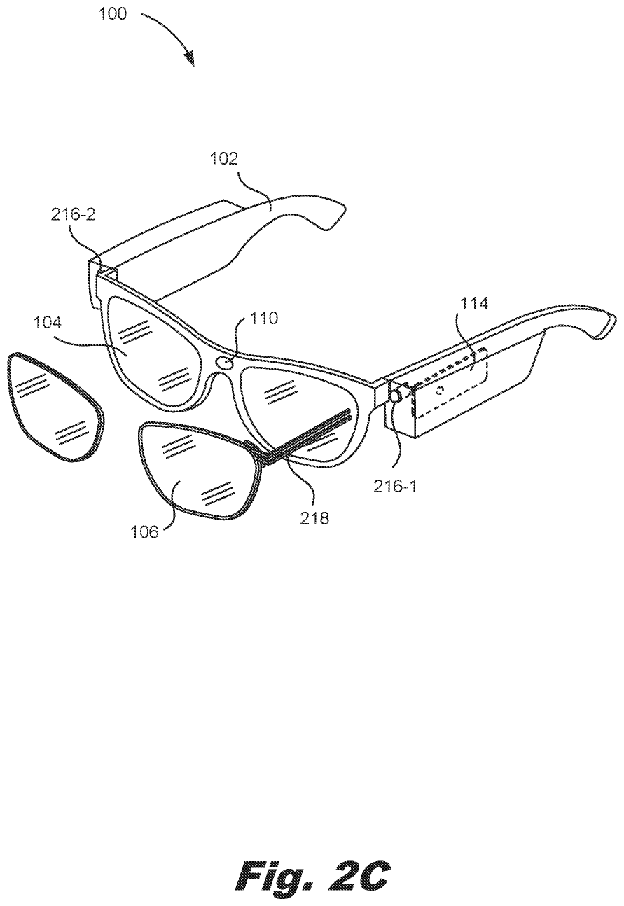

As described above, one form of XR is augmented reality (AR), where virtual content is presented on a lens (104) through which the user views a physical scene. As such, the XR system (100) may be AR glasses that includes the lens (104) and a frame (102) to retain the lens (104) in front of the user. FIGS. 2A-2C depict an example of AR glasses as described herein.

As described above, improper contrast between the environment and the virtual content may render the virtual content unrecognizable. That is, ambient light may wash out the virtual content. The present XR system (100) with the switch layer (106) aims to address this and other issues.

The XR system (100) includes an imaging system (108) that presents the virtual content on the lens (104). The imaging system (108) may take a variety of forms. For example, the imaging system (108) may include a projection unit which projects the virtual content onto the lens (104). In another example, the imaging system (108) includes a liquid crystal display (LCD) system or a light-emitting diode (LED) system which presents the content on the transparent lens (104). While reference is made to specific imaging system (108) types, the imaging system (108) may be of any variety of types which presents content on a transparent lens (104) substrate.

The XR system (100) includes a switch layer (106) disposed over the lens (104). The switch layer (106) has a selectively alterable transparency. That is, an applied stimulus alters the properties of the switch layer (106) to change the transparency, or light transmissivity through the switch layer (106) and lens (104). The change in transparency affects the viewability of the virtual content displayed on the lens (104). For example, in a bright environment, it may be difficult to see lens-projected virtual content due to a lack of contrast between the ambient light and the virtual content. Accordingly, by changing the transparency, the contrast between light that reaches the user through the lens (104) and the virtual content is increased, which makes the virtual content more discernible.

The switch layer (106) may take a variety of forms as well. For example, the switch layer (106) may be an electrochromic film or layer. An electrochromic film or layer may change its light transmission rate based on an applied electrical voltage. For example, the electrochromic layer may be opaque or translucent when no voltage is applied and may become transparent when a voltage is applied, with the degree of translucency or opacity being based on the value of the drivel electrical voltage.

In yet another example, the switch layer (106) may rely on the movement of lithium ions between electrodes to provide the selective transparency. For example, the switch layer (106) may include sub-layers, including a separator between two electrodes. Lithium ions migrate back and forth between the electrodes within the separator. When the layer is transparent, the lithium ions reside against one electrode. When the layer is opaque, the lithium ions reside against the other electrode. Applying a voltage drives the lithium ions from one electrode to the other or vice-versa.

Materials for the electrodes may vary. One electrode, the electrode against which the lithium ions sit when the switch layer (106) is transparent, may be formed of a material such as lithium cobalt oxide (LiCoO₂) or another such material. When a voltage is applied to the electrodes, the ions migrate through the separator to the other electrode, which may be a different material such as polycrystalline tungsten oxide (WO₃). The lithium ions cause the tungsten oxide layer to reflect light, thus rendering this layer opaque. The lithium ions will remain on a particular electrode until the voltage is reversed. As such, no power is used to maintain a lithium-ion electrochromic switch layer (106) transparent or opaque. An applied potential is just to change between states.

In a variation of this example, rather than having a separator between the electrode layers, the switch layer (106) may include an electrochromic material (i.e., a dye) that changes color when a current passes through. For example, a chemical die such as viologen may change reversibly between clear and blue/green. Accordingly, the contrast may be selectively adjusted via an electrical voltage which alters the amount of coloration in the electrochromic die that overlays the lens (104).

In another example, the switch layer (106) may be a polymer-dispersed liquid crystal (PDLC) layer in which liquid crystals are dispersed in a polymer. When no voltage is applied, the light is scattered at the interface of the layer due to the liquid crystals not being aligned with one another. In such a light scattering state, the PDLC switch layer (106) is opaque. However, when a voltage is applied, the crystals align with one another and light passes more readily therethrough. In this state, the PDLC switch layer (106) is transparent. Again, the degree of transparency/opacity is based on a value of the voltage passed through the switch layer (106). As described herein, the switch layer (106) may be in the form of a film that is adhered to the lens (104) or may be a rigid layer adjacent, or integrated with, the lens (104). While reference is made to particular switch layers (106), a variety of switch layers (106) may be implemented in accordance with the principles described herein.

The XR system (100) may also include a front-facing sensor (110) to measure an ambient brightness of the physical scene. As described above, ambient brightness may impact the viewability of virtual content. For example, brighter ambient light may wash out projected virtual content making it more difficult to see. Accordingly, the front-facing sensor (110), which may be a color camera, may capture the ambient light of the environment of the XR system (100).

In general, the front-facing sensor (110) is a photodetector that is to sense the amount of ambient light present. Light may be detected on a sensor in a variety of ways. In one example, a sensor may record the characteristics of light based on its red, green, and blue (RBG) qualities. However, a sensor may record the characteristics of light in other “spaces.” One such example is the CIELAB color space which defines light based on its red, green, yellow, and blue qualities. The CIELAB color space also has a value L* which is indicative of the lightness of the light. Accordingly, a front-facing sensor (110) that operates in the CIELAB color space may define the light in terms of its brightness such that an ambient brightness for the whole physical scene within the field of view of the front-facing sensor (110) may be determined. While reference is made to a particular color space for determining ambient light brightness, other color spaces may be implemented as well, such as the YUV color space.

As described above, this measured brightness value serves as a basis for a transparency adjustment to the switch layer (106). In an example, the front-facing sensor (110) may measure light brightness on a per-pixel scale. The transparency-triggering brightness value may be an averaged value across the sensor field of view, a value where measurements near a central portion of the field of view are more heavily weighted, or a targeted value where measurements at some predetermined or user-selected region of the field of view are more heavily weighted.

The XR system (100) also includes a tracking system (112) to record a position and orientation of physical objects in the physical scene. That is, to create a realistic and aesthetically-pleasing AR environment, it may be desirable for the virtual content to be rendered geometrically and positionally accurate relative to the elements of the physical scene. For example, it may be desirable for a human avatar depicted beside a tree and a flower to be taller than the flower but shorter than the tree. Moreover, as the user of the AR glasses moves towards the human avatar, that human avatar should increase in perceived size as would occur should the user of the AR glasses draw nearer a real human. The tracking system (112) facilitates this adjustment of the position and orientational information of the virtual content. Specifically, the tracking system (112), which may include an optical sensor(s) such as one or multiple infrared cameras, determines the position and orientation of various physical objects as well as their position relative to the user. As one example, the tracking system (112) may implement a simultaneous localization and mapping (SLAM) protocol to map the physical environment as well as the wearer's location within the environment.

Such a tracking system (112) may also track the different objects over a sequence of frames to determine the movement of the different objects and the user relative to one another. As an example, as a user walks towards a tree, the relative distance between the user and the tree changes, i.e., gets smaller. As such, the tree appears larger within the field of view of the user. As such, there is a relationship between user/object relative movement and the perception of those objects.

The tracking system (112) records this information which is used by the XR system (100) to alter the appearance of the virtual objects therein. For example, knowing the relative distances between different physical objects and the user allows the XR system (100) to place virtual content within the XR environment relative to the physical objects. That is, knowing the coordinates of the different objects in the physical environment allows the XR system (100) to display virtual objects realistically as if they were placed in particular locations within the environment.

Moreover, movement of the user changes the visual perception of physical objects. For example, as a user walks around a tree, the user sees the tree from different angles. Accordingly, by capturing and tracking the movement of the user relative to the physical objects, the XR system (100) can alter the display of the virtual content to match the changed perspective of the user.

The XR system (100) also includes a controller (114) to apply an electrical voltage to the switch layer (106) to adjust a strength of light passing through the lens (104). That is, as described above, the switch layer (106) has a selectively alterable transparency such that light passing through the lens (104) is attenuated or allowed to pass at full strength. Accordingly, by adjusting the transparency of the light passing through the lens (104), the switch layer (106) and controller (114) allow for a predetermined contrast ratio between the virtual content and the ambient light to enhance virtual content viewability.

The degree to which the transparency of the switch layer (106) is altered may depend on the brightness of the ambient light. For example, in bright conditions, where the lack of contrast is high, the transparency may be more greatly reduced. By comparison, in lower light conditions, where the lack of contrast is not as high, the transparency may be reduced to a lesser degree.

An ambient contrast ratio (ACR) may be used to measure a display's performance in the presence of ambient light. Accordingly, upon receiving the measured brightness value, the controller (114) may determine the transmittance of the switch layer (106) to achieve a target ACR. ACR may be evaluated using Equation (1) below.

$$ACR = \frac{{L}_{on} + {L}_{ambient} \times T}{{L}_{off} + {L}_{ambient} \times T} \qquad Equation ( 1 )$$

In Equation (1), Lₒₙ is a property of the lens (104) which is an on-state luminance having units of nit, L_{off} is a property of the lens (104) which is an off-state luminance. That is, a display may have an “on” and “off” state to indicate the light transmission path of pixels through the display. Thus, a brightness varies based on the state.

L_{ambient} is the measured luminance of the ambient light and T is the transmittance or transparency of the lens (104). By way of reference, L_{ambient} in an office may be around 150 nits and L_{ambient} on an overcast day may be around 300 nits. Adjusting the switch layer (106) transparency as described above may alter T in Equation (1) above. Accordingly, by adjusting the transparency, T, of the switch layer (106), a target ACR may be achieved.

Different ACR values indicate the relative contrast between ambient light and the display of the virtual content. Accordingly, the contrast may be adjusted to achieve a target ACR. For example, the transparency of the switch layer (106) may be adjusted to achieve an ACR of 3:1, 5:1, or 10:1.

In addition to changing the transparency of the switch layer (106), the controller (114) may adjust a brightness of the virtual content. This adjustment may be based on the measured brightness of the physical scene. For example, if the front-facing sensor (110) detects that the AR glasses are being used in a well-lit environment, the controller (114) may increase the brightness of the virtual content in addition to any alteration of the transparency of the switch layer (106). Doing so may provide even more customization to the virtual content-enhancing alterations of the XR system (100). In another example, the brightness of the virtual content may be held constant while the transparency of the switch layer (106) is altered.

As compared with other solutions, the present XR system (100) provides a lighter solution as accessory sun shields added to an XR system may prove cumbersome and heavy on a user's head. Moreover, as described above, the transparency of the switch layer (106) is automatically adjustable with regards to the ambient light conditions to ensure a target contrast and color saturation under various ambient lighting conditions.

Moreover, in some examples described below, the ambient light brightness may be calculated for a particular region of interest surrounding the virtual content, rather than for the entire field of view of the front-facing sensor (110). Compared with calculating the overall brightness of the image, calculating the brightness for a target region of the image may be more accurate and efficient as it may account for dramatic brightness variances over the ambient environment, (i.e., standing in front of a door with half out-door and half in-door environment).

Still further, because ambient brightness is accounted and adjusted for, a maximum display brightness setting, which may be otherwise used to evaluate a display's performance, is less relevant. As such, different display types that have a lower luminance may be implemented in XR systems (100).

FIGS. 2A-2C are diagrams of the XR system (100) with adjustable lens transparency, according to an example of the principles described herein. Specifically, FIG. 2A depicts an isometric view of an AR glasses-type XR system (100). FIG. 2A clearly depicts the frame (102) with the lens (104) inserted therein. As described above, the XR system (100) includes a switch layer (106) disposed over the lens (104), such that the lens (104) is not visible in FIG. 2A. As depicted in FIG. 2C, the switch layer (106) may be disposed on a side of the lens (104) that is opposite the user. However, in other examples, the switch layer (106) may be on a side of the lens (104) that is on the same side of the user. That is, the switch layer (106) may be between the lens (104) and the user.

Note that FIGS. 2A and 2C depict the controller (114) in dashed lines to indicate its position inside the frame (102). In other examples, the controller (114) may be on a separate device and remotely located from the frame (102) and other components of the XR system (100).

FIGS. 2A-2C also depict the tracking system (112), which in this case is a pair of cameras (216-1, 216-2) on either side of the frame (102) that are directed forward away from the user, such that the cameras (216) may capture the physical scene in front of the user. FIG. 2A also depicts the front-facing sensor (110) which, like the tracking system (112), is facing forward to capture ambient brightness in front of the user.

FIG. 2B also depicts the imaging system (108), which in the example of FIG. 2B, includes a projecting unit which projects the virtual content on to the lens (104). FIG. 2B also specifically depicts the tracking system (112), which in this example includes two cameras (216-1, 216-2) directed towards the physical scene that the user is viewing.

FIG. 2C is an exploded view of the XR system (100) to depict the relationship between the switch layer (106) and the underlying lens (104). FIG. 2C also depicts the electrical traces (218) that pass from the controller (114) to the switch layer (106) to effectuate the change in transparency previously described. Note that while FIGS. 2A-2C depict a particular configuration of the components, different configurations are anticipated by the present disclosure. For example, while FIGS. 2A-2C depict a particular position within the frame (102) of the tracking system (112), front-facing sensor (110), and controller (114), these components may be placed elsewhere on the XR system (100).

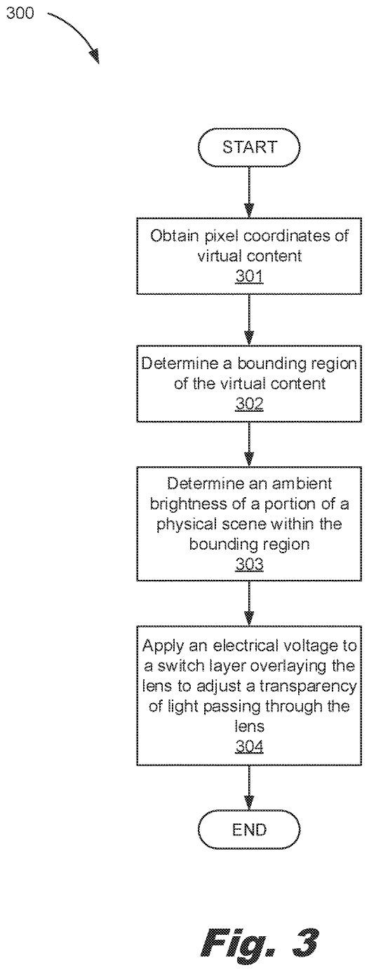

FIG. 3 is a flow chart of a method (300) for selectively adjusting lens transparency, according to an example of the principles described herein. According to the method (300), pixel coordinates are obtained (block 301) for the virtual content. These obtained (block 301) pixel coordinates are from a perspective of the front-facing sensor (110) of the XR system (100). That is, each pixel of content is identified with coordinates that identify its projected location on the front-facing sensor (110). In an example, these coordinates may be obtained (block 301) from the metadata associated with the virtual content. In another example, these coordinates may be retrieved from a 3D coordinate space from a simultaneous location and mapping (SLAM) operation being performed.

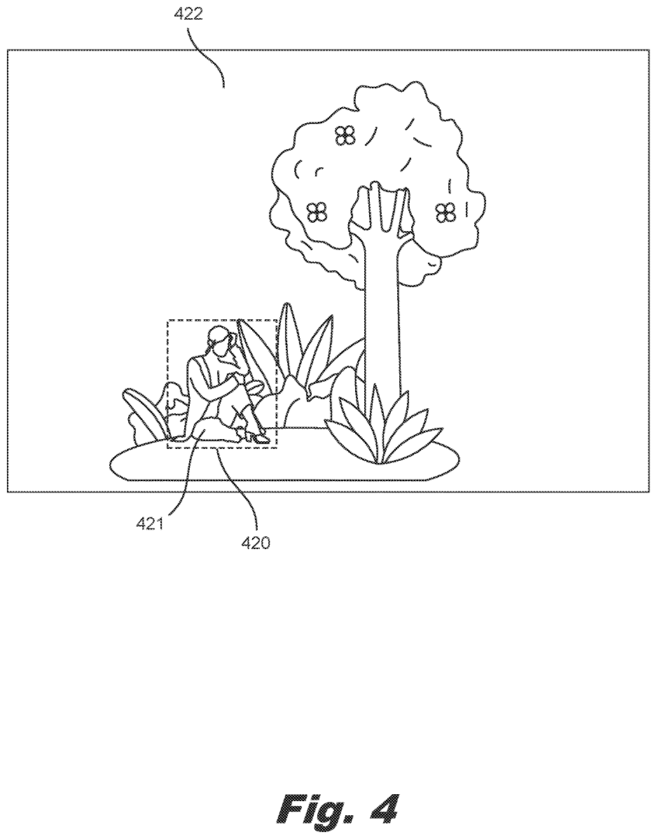

Once the pixel coordinates of the virtual content are obtained (block 301), the controller (114) may determine (block 302) a boundary region of the virtual content based on the pixel coordinates of the virtual content. During this operation, the controller (114) identifies a smallest rectangular boundary that surrounds the virtual content. The front-facing sensor (110) determines (block 303) the ambient brightness of the portion of the physical scene within the boundary region. That is, rather than calculating or averaging brightness values across the whole field of view of the front-facing sensor (110), in this example brightness values are calculated for just the field of view within the boundary region. As such, any brightness-based transparency adjustment is customized to that region immediately surrounding the virtual content. More specifically, the adjustment made to switch layer (106) transparency to enhance contrast with the virtual content is specifically tailored to the existing contrast, or lack thereof, surrounding the virtual content. Note that in this example, the transparency adjustment of the whole switch layer (106) is tied to a localized determination of ambient light brightness. FIG. 4 depicts a pictorial representation of a physical scene with virtual content disposed thereon and a boundary region around the virtual content.

The controller (114) then applies (block 304) an electrical voltage to the switch layer (106) overlying the lens (104) to adjust a transparency of the lens (104) and adjust the strength of light passing through the lens (104).

In an example, the value of the electrical voltage is based on a measured brightness of the physical scene within the boundary region. That is, as described above, the switch layer (106) may have multiple incremental transparencies. For example, the overall transparency of the switch layer (106) may be defined on a scale from 0%, where the switch layer (106) is completely opaque, to 100%, where the switch layer (106) is completely transparent. Different voltage values may alter the switch layer (106) to different degrees to effectuate a different transparency percentage. For example, a first voltage value may set the switch layer (106) to 50% transparency where a higher voltage value may increase the visibility, i.e., increase the transparency. Accordingly, the value of the transparency may be dictated by the ambient brightness, with brighter ambient light triggering a less transparent display. In this example, the percent reduction in transparency is dictated by the boundary region brightness.

In a particular example, the measured ambient brightness which triggers the application of electrical voltage is an averaged, weighted, or targeted brightness. This averaged, weighted, or targeted brightness may consider measurements across the whole field of view of the front-facing sensor (110) or may consider measurements just within the boundary region. For example, measurements may be considered across the whole field of view of the front-facing sensor (110) with those measurements that fall within the boundary region being more heavily weighted. In another example, measurements may be considered across the boundary region, with those measurements nearer the center of the boundary region being more heavily considered. As such, in this example, certain locations/regions of the field of view of the front-facing sensor (110) are more heavily weighted such that measurements from those locations are more highly considered in determining any adjustment to the transparency of the switch layer (106).

FIG. 4 depicts an augmented reality (AR) scene (422) as depicted from a front-facing sensor (110), according to an example of the principles described herein. In the example depicted in FIG. 4, the scene (422) includes real-world elements of a tree and grass with virtual content of an avatar (421) disposed within the scene (422). As described above, the position, size, and orientation of the avatar (421) is determined based on measurements/coordinates indicative of the relative position of the user and the real-world elements. That is, coordinate measurements indicate a relative positioning of the real-world elements to a wearer of the XR system (100). These coordinates may be used to generate coordinates for the avatar (421) such that the avatar (421) has a desired relative position, size, shape, and orientation to provide a convincing or desired XR environment. For example, based on measurements for the tree, the controller (114) may determine a size of the avatar (421) relative to the tree. This may be done per-frame, or after a predetermined number of frames, to account for movement of the user and/or objects depicted on/through the lens (104). For example, as a user moves towards the scene (422) elements therein become larger. As such, the controller (114) may adjust the size of the avatar (421) to coincide with the movement of the user and/or objects.

FIG. 4 also depicts the boundary region (420) surrounding the avatar (421) on the image captured by the front-facing sensor (110). As described above, the controller (114) may determine a brightness of the boundary region (420) and determine the value of the transparency-changing electrical voltage based on the measured brightness within this boundary region (420). Doing so may provide a contrast that is specifically targeted to the virtual content, thus ensuring the viewability of the virtual content. That is, were the brightness determined across the whole scene (422), which may have a combination of well-lit and low-lit regions, a particular transparency adjustment may be suggested which accounts for the average brightness of the entire field of view. However, the virtual content may be found within a well-lit region of the scene (422), such that an adjustment based on well-lit and low-lit regions may not be sufficient to result in a target ACR for the virtual content in the well-lit region. Accordingly, by selecting a transparency adjustment on that region immediately surrounding the virtual content, the XR system (100) provides a greater likelihood that the virtual content will be distinguishable from the real-world background.

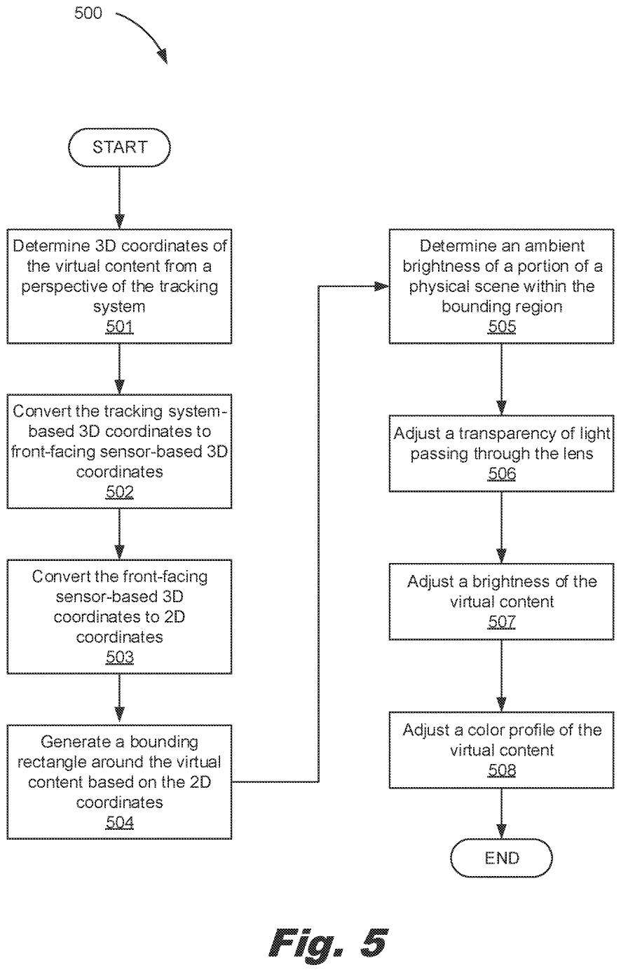

FIG. 5 is a flow chart of a method (500) for selectively adjusting lens (104) transparency, according to an example of the principles described herein.

As described in connection with FIG. 3, the boundary region (420) of the virtual content may be determined. In some examples, this includes generating two-dimensional (2D) coordinates for the virtual content from the perspective of the front-facing sensor (110) such that front-facing sensor (110) measurements of brightness in that boundary region (420) may be determined and applied to the 2D projection of the virtual content. However, as the virtual content is not a real-world element, the front-facing sensor (110) does not detect the virtual content, and as such there are no 2D pixel coordinates for the avatar (421) from the front-facing sensor (110). Accordingly, the present method (500) generates 3D coordinates for the virtual content and converts such to 2D coordinates such that a transparency-adjusting boundary region (420) may be defined.

First, the controller (114) determines (block 501) the 3D coordinates of the virtual content from a perspective of a tracking system (112) of the XR system (100). As described above, the tracking system (112) logs the position and orientation information for the real-world objects over time. Specifically, the tracking system (112) outputs data indicative of the coordinates for the real-world objects in the scene (422). From these real-world object coordinates, the controller (114) may determine where in the scene, as defined by coordinates, the virtual content is to be placed to have a desired effect. In the example depicted in FIG. 4, this may include placing the avatar (421) in a location adjacent the tree, with a size that is based on the relative size of the tree. From the physical object 3D coordinates, the controller (114) may determine the avatar 3D coordinates (X_{c1}, Y_{c1}, and Z_{c1}). However, these coordinates are from the perspective of the tracking system (112) and it may be desired to have coordinates from the perspective of the front-facing sensor (110) to ensure that the boundary region (420) is defined from the perspective of the front-facing sensor (110). That is, the front-facing sensor (110) is in a different position on the frame (102) than the tracking system (112) such that each component has a different viewpoint.

Accordingly, the 3D coordinates of the virtual content from the perspective of the tracking system (112) are converted (block 502) into 3D coordinates from a perspective of the front-facing sensor (110). Between the components, extrinsic calibration parameters such as a distance between the tracking system (112) and the front-facing sensor (110) are defined to connect the two viewpoints and this conversion (block 502) facilitates moving between the two coordinate planes. That is, this conversion (block 502) depends on a point in world coordinates and several calibration parameters, such as the physical dimensions of the XR system (100) and more specifically the physical dimensions of the frame (102) and the relative location of the tracking system (112) and front-facing sensor (110) on the frame (102). Such calibration parameters may include a translation vector and a rotation matrix connecting the two viewpoints.

Following this conversion, the virtual content has 3D coordinates (X_{c2}, Y_{c2}, Z_{c2}) from the perspective of the front-facing sensor (110). The 3D coordinates of the virtual contents are converted (block 503) to two-dimensional (2D) coordinates. That is, the virtual content and other content of the physical scene have three dimensions, X, Y, and Z, however content detected by a front-facing sensor (110) is defined in two dimensions, X and Y. Accordingly, the 3D coordinates of the virtual content are converted to the 2D coordinate plane to determine the 2D coordinate boundary region (420) dimensions. Conversion of 3D coordinates to a 2D coordinate plane may be referred to as projection.

Let (x₃, y₃) represent the 2D coordinates of the virtual content and (X_{c2}, Y_{c2}, Z_{c2}) represent the 3D coordinates of the virtual content. In this example, the coordinate mapping may be defined by Equation (2) below.

$${z}^{′} [ \begin{matrix}{x}_{3} \\ {y}_{3} \\ 1\end{matrix} ] = K \times M \times [ \begin{matrix}{X}_{c 2} \\ {Y}_{c 2} \\ {Z}_{c 2}\end{matrix} ] \qquad Equation ( 2 )$$

In Equation (2), z′ represents a scaling factor, K is an intrinsic parameter matrix which quantitatively characterizes parameters of the image sensor (including Charge Coupled Device (CCD) or Complementary Metal-Oxide Semiconductor (CMOS)); and M expresses the transformation between the vision coordinate system (VCS) and the world coordinate system. Transformation matrix M includes the rotation matrix R and the translation matrix T. As described above, such projection may be based on the intrinsic camera parameters.

Once the 2D coordinates for the virtual content are determined as described above, a bounding rectangle may be generated (block 504) around the virtual content based on the 2D coordinates of the virtual content. This may be performed as described above in connection with FIG. 3.

The method (500) may include determining (block 505) the ambient brightness of a portion of the physical scene within the boundary region (420) and adjusting (block 506) a transparency of light passing through the lens (104). These operations may be performed as described above in connection with FIG. 3.

In addition to changing the transparency of the switch layer (106), other parameters of the XR system (100) may be adjusted. For example, a brightness of the virtual content may be adjusted (block 507) based on a measured brightness of the physical scene within the boundary region (420). This provides another tunable parameter of the XR system (100) to achieve a target ACR for the virtual content. In another example, the display brightness may be held constant while the switch layer (106) transparency is adjusted. As another example, a color profile of the virtual content may be adjusted (block 508) based on a measured brightness of the physical scene within the boundary region, thus providing another tunable parameter of the XR system (100).

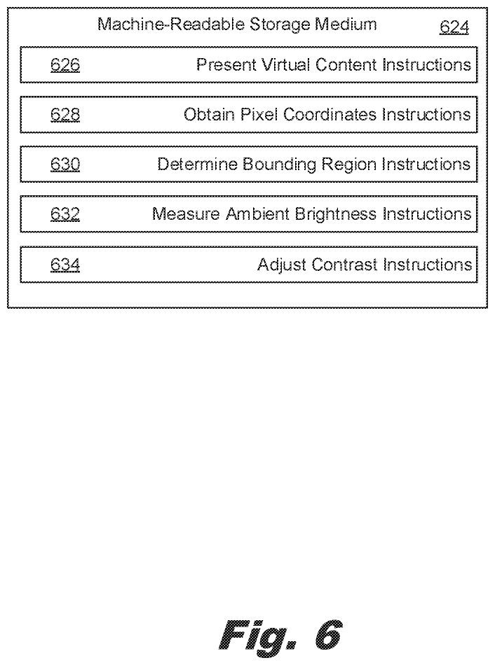

FIG. 6 depicts a non-transitory machine-readable storage medium (624) for selectively adjusting lens transparency, according to an example of the principles described herein. To achieve its desired functionality, the XR system (100) includes various hardware components. Specifically, the XR system (100) includes a processor and a machine-readable storage medium (624). The machine-readable storage medium (624) is communicatively coupled to the processor. The machine-readable storage medium (624) includes several instructions (626, 628, 630, 632, 634) for performing a designated function. In some examples, the instructions may be machine code and/or script code.

The machine-readable storage medium (624) causes the processor to execute the designated function of the instructions (626, 628, 630, 632, 634). The machine-readable storage medium (624) can store data, programs, instructions, or any other machine-readable data that can be utilized to operate the XR system (100). Machine-readable storage medium (624) can store machine-readable instructions that the processor of the XR system (100) can process, or execute. The machine-readable storage medium (624) can be an electronic, magnetic, optical, or other physical storage device that contains or stores executable instructions. Machine-readable storage medium (624) may be, for example, Random-Access Memory (RAM), an Electrically Erasable Programmable Read-Only Memory (EEPROM), a storage device, an optical disc, etc. The machine-readable storage medium (624) may be a non-transitory machine-readable storage medium (624).

Referring to FIG. 6, present virtual content instructions (626), when executed by the processor, cause the processor to present virtual content on a lens (104) of an XR system (100), wherein a user views a physical scene through the lens (104). Obtain pixel coordinates instructions (628), when executed by the processor, cause the processor to, obtain pixel coordinates for the virtual content. Determine boundary region instructions (630), when executed by the processor, cause the processor to, determine, based on the pixel coordinates of the virtual content, a boundary region (420) of the virtual content. Measure ambient brightness instructions (632), when executed by the processor, cause the processor to measure, with a front-facing sensor (110), an ambient brightness of the physical scene within the boundary region (420). Adjust contrast instructions (634), when executed by the processor, cause the processor to adjust a contrast between the physical scene visible through the lens (104) and the virtual content based on a measured ambient brightness of the physical scene within the boundary region (420) by selectively altering a transparency of the switch layer (106) overlying the lens (104).

In summary, such a system, method, and machine-readable storage medium may, for example, 1) provide a target contrast ratio between virtual content displayed on a transparent lens and real-world physical objects viewable through the transparent lens; 2) are lightweight without an accessory component for the XR system; 3) automatically adjust the contrast; 4) determine transparency based on ambient light specifically around the virtual content; and 5) are power efficient. However, it is contemplated that the devices disclosed herein may address other matters and deficiencies in a number of technical areas, for example.

What is claimed is:

1. An extended reality (XR) system, comprising:
a lens through which a user is to view a physical scene and onto which virtual content is displayed;
a frame to retain the lens in front of the user;
an imaging system to present the virtual content on the lens;
a switch layer disposed over the lens, wherein the switch layer has a selectively alterable transparency;
a front-facing sensor to measure an ambient brightness of the physical scene;
a tracking system to record a position and orientation of objects in the physical scene; and
a controller to, based on a measured brightness of the physical scene, apply an electrical voltage to the switch layer to adjust a strength of light passing through the lens.

2. The XR system of claim 1, wherein the controller is to adjust a brightness of the virtual content based on the measured brightness of the physical scene.

3. The XR system of claim 1, wherein the switch layer is disposed on a side of the lens opposite the user.

4. The XR system of claim 1, wherein the tracking system comprises an optical sensor.

5. The XR system of claim 1, wherein:
the controller is to determine a brightness of a boundary region of the physical scene visible through the lens; and
a value of the electrical voltage is based on a measured brightness of the boundary region.

6. The XR system of claim 1, wherein a value of the electrical voltage is based on an averaged, weighted, or targeted brightness of the physical scene visible through the lens.

7. The XR system of claim 1, wherein the controller is integrated in the frame.

8. A method, comprising:
obtaining pixel coordinates of virtual content projected from a perspective of a front-facing sensor of an extended reality (XR) system;
determining, based on the pixel coordinates of the virtual content projected from the perspective of the front-facing sensor, a boundary region of the Virtual content;
determining, with the front-facing sensor facing a physical scene visible through s lens, an ambient brightness of a portion of the physical scene within the boundary region; and
applying an electrical voltage to a switch layer overlying the lens to adjust a transparency of light passing through the lens, wherein a value of the electrical voltage is based on a measured brightness of the physical scene within the boundary region.

9. The method of claim 8, wherein determining the boundary region comprises:
converting three-dimensional (3D) coordinates of the virtual content from the perspective of a tracking system to 3D coordinates of the virtual content from a perspective of the front-facing sensor;
converting the 3D coordinates of the virtual content from the perspective of the front-facing sensor to two-dimensional (2D) coordinates; and
generating a bounding rectangle around the virtual content based on the 2D coordinates.

10. The method of claim 9, wherein converting the 3D coordinates of the virtual content from the perspective of the tracking system to 3D coordinates of the virtual content from the perspective of the front-facing sensor is based on physical dimensions of a frame of XR system and relative position of components of the XR system.

11. The method of claim 8, further comprising adjusting a brightness of the virtual content based on the measured brightness of the physical scene within the boundary region.

12. The method of claim 8, further comprising adjusting a color profile of the virtual content based on the measured brightness of the physical scene within the boundary region.

13. The method of claim 8, wherein contrast is adjusted to achieve a 5:1 ambient contrast ratio (ACR).

14. A non-transitory machine-readable storage medium encoded with instructions executable by a processor, the machine-readable storage medium comprising instructions to:
present virtual content on a lens of an extended reality (XR) system, wherein a user views a physical scene through the lens;
obtaining pixel coordinates of the virtual content;
determine, based on the pixel coordinates of the virtual content, a boundary region of the virtual content;
measure, with a front-facing sensor facing the physical scene, an ambient brightness of the physical scene within the boundary region; and
based on a measured ambient brightness of the physical scene within the boundary region, adjust a contrast between the physical scene visible through the lens and the virtual content by selectively altering a transparency of a switch layer overlying the lens.

15. The non-transitory machine-readable storage medium of claim 14, wherein the measured ambient brightness within the boundary region comprises an averaged, weighted, or targeted brightness of the physical scene within the boundary region.
